(19) United States
(12) Patent Application Publication
(10) Pub. No.: US 2025/0390849 A1
(43) Pub. Date: Dec. 25, 2025

(54) Artificial Intelligence Based Integrated ACH Processing Platform

(71) Applicant: George McKee, Bradford Woods, PA (US)

(72) Inventor: George McKee, Bradford Woods, PA (US)

(21) Appl. No.: 19/200,588

(22) Filed: May 6, 2025

Related U.S. Application Data
(60) Provisional application No. 63/643,361, filed on May 6, 2024.

(51) Int. Cl. G06Q 20/02; G06Q 20/40

(52) U.S. Cl. CPC G06Q 20/023; G06Q 20/4016

(57) ABSTRACT

An AI-powered ACH processing platform configured for intelligent automation and real-time decision support, wherein the platform is integrated into the ACH processing workflow, including elements for ensuring compliance, and mitigating, and is configured to automates compliance checks, and configured to proactively monitors risks, wherein the AI-powered ACH processing platform includes an AI-powered assistant and a web-based natural interface with the AI-powered assistant in which users have the capability of interacting via natural text inputs with the platform.

### RELATED APPLICATIONS

The present invention claims the benefit of U.S. Provisional Patent Application Ser. No. 63/643,361 filed May 6, 2024 titled “Artificial Intelligence Based Integrated ACH Processing Platform”, which application is incorporated herein by reference.

### BACKGROUND OF THE INVENTION

### 1. Field of the Invention

The present invention relates to ACH Processing systems.

### 2. Background Information

AUTOMATED CLEARING HOUSE (ACH) is an electronic network for financial transactions in the United States. ACH processes large volumes of credit and debit transactions, generally in batches. Existing ACH credit transfers generally include direct deposit, payroll and vendor payments. Existing ACH direct debit transfers include consumer payments on insurance premiums, mortgage loans, and other kinds of bills.

ACH has been described as a payments system organized and administered by National Automated Clearing House Association (NACHA), which was founded in 1974 to improve the U.S payments system. It's the system through which trillions of dollars move between bank accounts each year.

Both the government and the commercial sectors use ACH payments. Businesses increasingly use ACH online to have customers pay, rather than via credit or debit cards. In 2013, this network processed nearly 22 billion ACH transactions with a total value of $38.7 trillion. In 2021, the ACH network processed 29.1 billion payments totaling more than $72.6 trillion. Credit card payments are handled by separate networks.

The traditional uses of the ACH payment system include bank treasury management departments selling this service to business and government customers; business-to-business payments; direct debit payment of consumer bills such as mortgages, loans, utilities, insurance premiums, rents, and any other regular payment; direct deposit of payroll, Social Security and other government payments, and tax refunds; E-commerce payments; federal, state, and local tax payments and charitable donations.

NACHA manages the development, administration, and governance of the ACH network, the backbone for the electronic movement of money and data in the United States. It is funded by the financial institutions it governs. The ACH Network serves as a network for direct consumer, business, and government payments, and annually facilitates billions of payments.

Utilized by all types of financial institutions, the ACH Network is governed in part by the NACHA Operating Rules, a set of rules that guide risk management and create certainty for all participants, and these rules are known to the participating financial institution. There are federal and state banking regulations effecting ACH processing. NACHA represents nearly 11,000 financial institutions via 17 regional payments associations and direct membership. The Federal Reserve Banks, through the FedACH system, are collectively the nation's largest ACH operator. In 2005, they processed 60% of commercial interbank ACH transactions; the remaining 40% was processed by the Electronic Payments Network (EPN), the United States' only private-sector ACH operator. EPN and the Reserve Banks rely on each other for the processing of some transactions when either party to the transaction is not their customer. These inter-operator transactions are settled by the Reserve Banks. Essentially all ACH members or stakeholders can have their own operating rules associated with processing ACH. Thus the relevant rules, regulations operating parameters that govern the ACH network are established by NACHA, the Federal Reserve, and federal and bank regulators and individual ACH stakeholders.

In the ever-evolving landscape of Automated Clearing House (ACH) processing, third-party senders, financial institutions, and regulatory bodies face a myriad of challenges. These include escalating transaction volumes, increasingly stringent compliance requirements, and the pressing need for enhanced security measures.

Amidst this complexity, advances in artificial intelligence (AI) and machine learning (ML) are opening new avenues for innovation in financial services. One of AI's primary contributions to the ACH Network has been proposed to be in the augmentation of efficiency. AI-driven algorithms are adept at processing and analyzing vast amounts of data in real time. In the context of ACH payments, this has been proposed to translate to faster transaction processing and, subsequently, quicker fund transfers. It has been proposed that Al complements faster transaction processing by ensuring that high-value transactions are processed swiftly and accurately. In sectors like insurance, where timely disbursement of funds is critical for homeowners facing unforeseen disasters, AI-powered systems have become proposed as a vital cog in the wheel. AI's proficiency in handling large volumes of transactions has been proposed to not only expedite the payment process but also minimizes the likelihood of errors. This is particularly important in the B2B sphere, where precision is paramount. Businesses making significant vendor payments and conducting inter-business transfers benefit from AI's error-reduction capabilities, ensuring that financial transactions proceed without hitches. AI has been proposed in the ACH field to not only enable speed but also to contribute to the overall reliability and accuracy of these transactions.

While proposed AI integration in ACH can greatly increase processing speed and accuracy it has not been integrated with stakeholders and addressing compliance or enhancing security.

It is the object of the present invention to address the deficiencies of existing ACH processing platforms to improve platforms for addressing escalating transaction volumes, increasingly stringent compliance requirements, and the pressing need for enhanced security measures.

### SUMMARY OF THE INVENTION

The present invention maintains all of the advantages existing ACH processing platforms and provides an AI-powered ACH processing platform designed to transform ACH transaction processing through intelligent automation and real-time decision support. The artificial intelligence based integrated ACH processing platform of the invention integrates seamlessly into the ACH processing workflow, enhancing efficiency, ensuring compliance, and mitigating risks effectively. With its cutting-edge technology, the artificial intelligence based integrated ACH processing platform of the invention provides in-the-moment guidance, automates compliance checks, and proactively monitors risks, enabling unprecedented speed, accuracy, and confidence in transaction processing.

These and other advantages of the present invention will be clarified in the following description of the invention in which like reference numbers represent like elements throughout.

### BRIEF DESCRIPTION OF THE FIGURES

FIG. 1 is a representative screenshot of an introductory page of a web-based natural interface with an AI-powered assistant artificial intelligence based integrated ACH processing platform of the invention;

FIG. 2 is a representative screenshot of a web-based natural interface with the AI-powered assistant artificial intelligence based integrated ACH processing platform of FIG. 1;

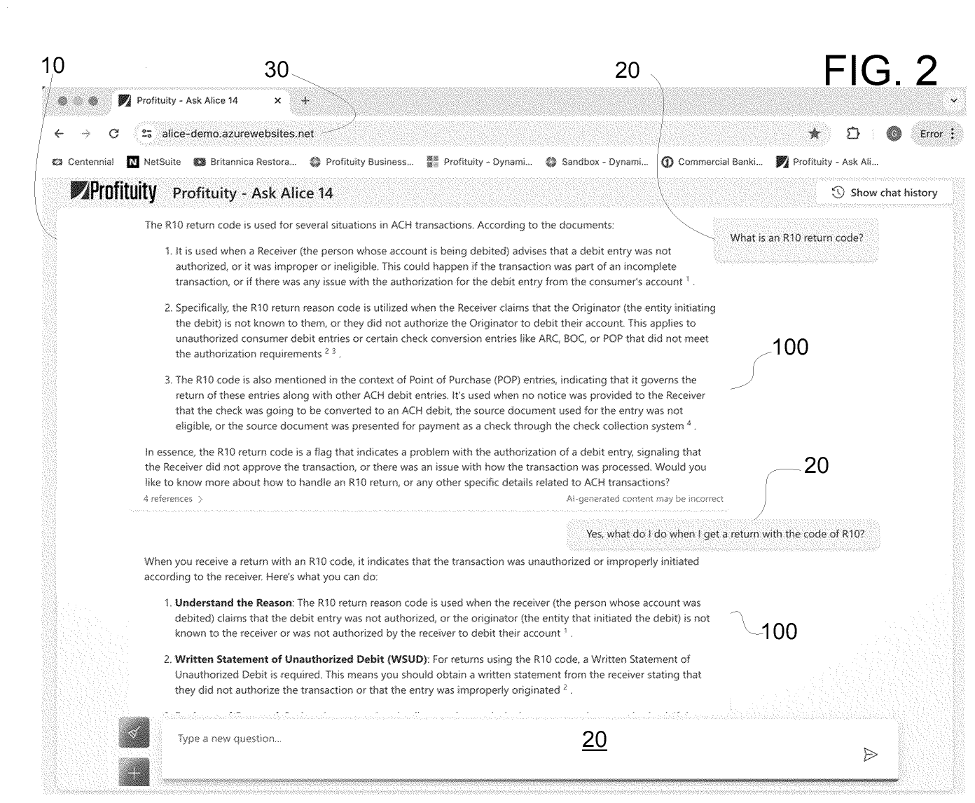

FIG. 3 is a schematic representation of the interaction of the AI-powered assistant artificial intelligence based integrated ACH processing platform of FIG. 1 with relevant stakeholders.

### DESCRIPTION OF THE PREFERRED EMBODIMENTS

The artificial intelligence based integrated ACH processing platform 100 of the invention is, or includes, an AI-powered assistant (Alice) that embeds intelligent automation and real-time decision support directly into the ACH processing workflow. Providing in-the-moment guidance, automated compliance checks, and proactive risk monitoring, allows the system 100 of the invention to empower Third-Party Senders 120 (TPSs) and Financial Institutions (FIs) to process ACH transactions with unprecedented speed, accuracy, and confidence.

This artificial intelligence based integrated ACH processing platform 100 of the invention transforms the traditional ACH operational model by addressing the inefficiencies of accessing multiple systems to adhere to diverse compliance and regulatory standards, including Nacha rules 110, guidelines from Originating Depository Financial Institutions (ODFIs), and internal compliance frameworks 150.

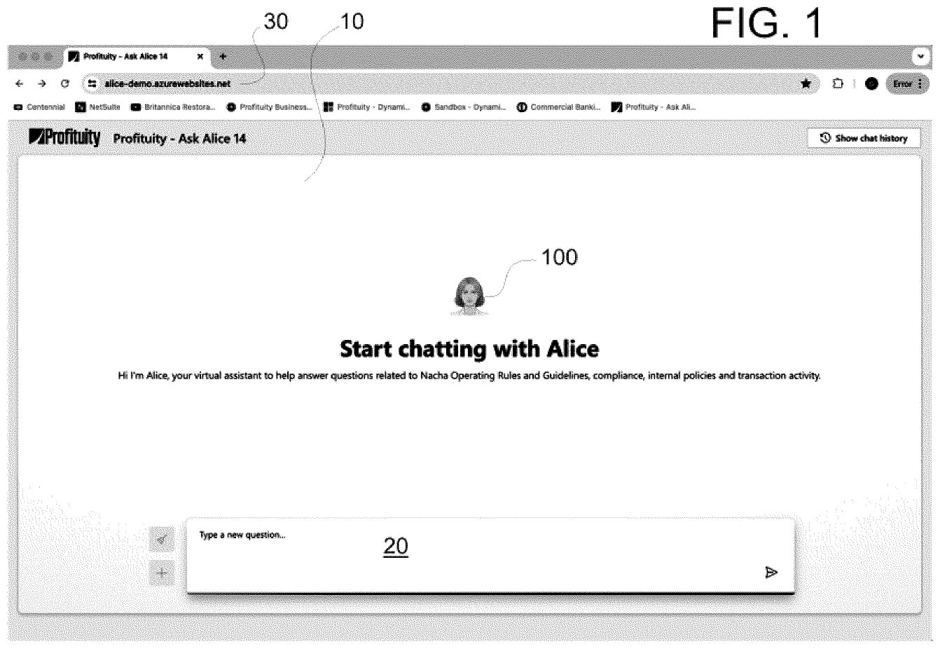

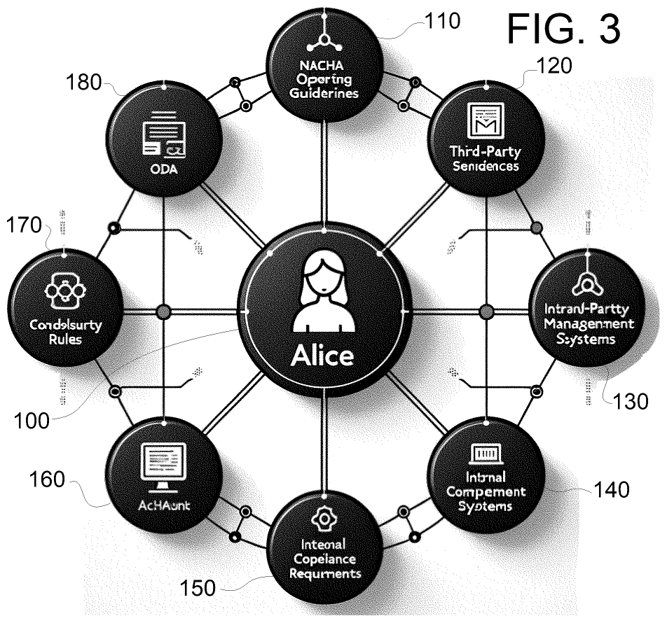

FIG. 1 is a representative screenshot of an introductory page of a web-based 30 natural interface 10 with an AI-powered assistant artificial intelligence based integrated ACH processing platform 100 of the invention in which users have the capability of interacting via natural text inputs 20 with the platform 100. FIG. 3 is a representative illustration of this interaction with repeated inputs 20 and responses listed as representative of the platform 100.

As a sophisticated, contextual layer within the operational workflow, the artificial intelligence based integrated ACH processing platform 100 of the invention not only serves as an interactive interface 10 but acts as a dynamic synthesis of relevant transactional and regulatory information via interfacing with stakeholders 110, 120, 130, 140, 150, 160 170 and 180 as shown in FIG. 3. This capability allows ACH operators to receive real-time, context-aware guidance and take necessary corrective actions without disrupting their workflow.

For example, if a transaction requires re-authorization due to a specific return code, the artificial intelligence based integrated ACH processing platform 100 of the invention not only notifies the operator of the issue in a regulatory context but also provides the required authorization forms directly within the system 100. This functionality not only maintains compliance with stringent regulatory standards but also enhances the efficiency and accuracy of compliance-related decisions.

By integrating comprehensive decision-making support and facilitating immediate action on compliance and operational issues, the artificial intelligence based integrated ACH processing platform 100 of the invention significantly improves operational continuity, compliance adherence, and system reliability, thereby revolutionizing financial transaction management and setting a new benchmark for ACH processing systems.

The artificial intelligence based integrated ACH processing platform of the invention includes certain attributes that have been summarized as Automated Lifelike, Integrated, Compliance Engine, or the ALICE brand platform 100 for ACH processing. The specifics of the ACH processing outside of the AI integration are well known. The AI platform 100 is fully automated. Lifelike refers to the design of mimicking a human interface in the platform. Integrated means the platform is configured to engage with all ACH stakeholders 110, 120, 130, 140, 150, 160, 170 and 180 as examples. Compliance Engine references that the platform facilitates compliance with all rules, regulations and operating parameters for ACH in a verifiable manner. The structure and capabilities of the Alice brand platform 100 are outlined herein. By addressing the specific needs of various stakeholders 110, 120, 130, 140, 150, 160, 170 and 180 in the ACH processing ecosystem, the Alice brand platform 100 not only streamlines operations but also pioneers a new standard in financial transaction management.

The Alice brand platform 100 harnesses the power of artificial intelligence (AI) and machine learning (ML) to redefine the landscape of ACH transaction processing. Here is some of the core technologies that power the Alice brand platform and how it integrates with existing stakeholder systems to deliver enhanced capabilities: a) AI and Machine Learning: Advanced algorithms for real-time analytics and automation; b) Natural Language Processing (NLP) and Response Augmented Generation yields a sophisticated engine for understanding and generating human-like responses; c) Automation and Robotics streamlines routine tasks and executes real-time risk alerts; d) API-Driven Integration enhances existing systems without the need for costly replacements, allowing for seamless data integration and extended functionality.

The Alice platform 100 offers transformative benefits to Third-Party Senders (TPS), Financial Institutions (FIs), and Regulators: a) For TPS: Real-time compliance, automated risk management, enhanced operational efficiency, and streamlined onboarding processes; b) For FIs: Comprehensive monitoring, proactive fraud detection, regulatory compliance automation, and enhanced customer management; c) For Regulators: Improved oversight capabilities, data-driven regulatory decisions, and enhanced compliance and enforcement.

The Alice brand platform 100 includes Advanced AI Integration: Pioneering integration of AI within ACH processing; b) API Flexibility: Extends the power of existing systems with minimal disruption; c) Customizable Risk Management Solutions: Tailored tools to suit specific operational needs; d) Seamless Regulatory Compliance: Automated updates to ensure ongoing compliance; e) Collaborative Platform Enhancements: Tools that enhance transparency and collaboration across stakeholders.

The Alice brand platform is poised to lead a significant transformation in ACH processing, catering to the growing demand for technological integration in financial services. It offers scalability, enhances strategic decision-making, and sets new industry standards, making it a valuable investment for the future of financial operations.

The Alice brand platform represents a revolutionary advancement in ACH transaction processing and where it integrates with stakeholders is outlined below:

1. An AI-powered ACH processing platform configured for intelligent automation and real-time decision support, wherein the platform is integrated into the ACH processing workflow, including elements for ensuring compliance, and mitigating, and is configured to automates compliance checks, and configured to proactively monitors risks, wherein the AI-powered ACH processing platform includes an AI-powered assistant and a web-based natural interface with the AI-powered assistant in which users have the capability of interacting via natural text inputs with the platform.
